(19) United States
(12) Patent Application Publication
(10) Pub. No.: US 2025/0011128 A1
(43) Pub. Date: Jan. 9, 2025

(54) METHOD FOR DETECTING OVERLOAD CONDITION, OVERLOAD MONITORING SYSTEM AND ELEVATOR

(71) Applicant: KONE Corporation, Helsinki (FI)

(72) Inventors: Tapani TALONEN, Helsinki (FI); Juha PANULA, Helsinki (FI); Marko SAARINEN, Helsinki (FI); Tarvo VIITA-AHO, Helsinki (FI); Jesse MÄNTYLÄ, Helsinki (FI); Ari KATTAINEN, Helsinki (FI); Riku LEPPÄAHO, Helsinki (FI)

(73) Assignee: KONE Corporation, Helsinki (FI)

(21) Appl. No.: 18/747,168

(22) Filed: Jun. 18, 2024

(30) Foreign Application Priority Data
Jul. 3, 2023 (EP) 23183166.0

(51) Int. Cl. B66B 5/00; B66B 1/34; B66B 5/14

(52) U.S. Cl. CPC B66B 5/0031; B66B 1/3476; B66B 5/145

(57) ABSTRACT

A method for detecting an overload condition of an elevator car of an elevator includes obtaining prevailing car-load information from a load weighing device arranged to weigh a prevailing car-load preferably when the elevator car is standing at a landing floor in an elevator shaft; determining if said prevailing car-load information fulfils one or more overload criteria; and generating a signal indicating an overload condition of an elevator car, if said car-load information fulfils one or more of said overload criteria; obtaining information of at least one operational parameter of the elevator; and adjusting one or more of said overload criteria or said car-load information based on said information of the at least one operational parameter of the elevator. An overload monitoring system and an elevator implementing the method are also disclosed.

### FIELD OF THE INVENTION

The invention relates to detection of overload of an elevator car. The elevator is in particular an elevator for transporting passengers and/or goods.

### BACKGROUND OF THE INVENTION

Elevator systems are manufactured with a rated load, and operation of the elevator system should not be allowed in case the load inside elevator car (hereinafter referred to as car-load) is too big. To obtain car-load information, elevator system is provided with a load weighing device (LWD) to measure the elevator car-load, e.g. from a component that is in force transmitting connection with the car. A load weighing device can measure the car-load by sensing the tension of one or more suspension ropes of the elevator, for instance. A control system may determine if said prevailing car-load information fulfils at least one overload criterium, such as exceeding of an overload threshold value. Typically, the control system compares the obtained car-load information, such as a measured prevailing car-load value, with an overload threshold value so as to determine if launch of the elevator run is allowed.

A drawback of known elevators has been that it is difficult to make the elevator usable close to its full transport capacity and with low likelihood of wrong alarms. It has been noticed that some elevators are sensitive to produce wrong alarms of an overload condition when the load in the car is close to the rated load. This has been taken into account for instance by setting the overload threshold value above the rated load of the elevator system with adequate margin such that triggering wrong alarms of an overload condition may be prevented.

### BRIEF DESCRIPTION OF THE INVENTION

The object of the invention is to introduce an improved solution for detecting overload condition of an elevator car with an improved accuracy. This can mean that wrong alarms of an overload condition may be avoided, even if small overload threshold margin is used. By means of the invention an overload situation may be already detected with a smaller overload of the elevator car than before, which improves elevator safety.

The object of the invention is to introduce an improved solution by which one or more of the above-mentioned problems of prior art and/or drawbacks discussed or implied elsewhere in the description can be alleviated.

It is introduced, inter alia, embodiments where effect of changes in mobility of the elevator car can be at least partially eliminated from the overload detection. The aforementioned changes can be due to many things during lifetime of an elevator. For example aging, wear or deterioration of components (e.g. guide shoes or guide rollers) or emerging lubrication issues or slight changes in positioning, surface properties or shape of guide rails (e.g. bulging) can change, typically reduce, mobility of an elevator car.

It is brought forward a new method for detecting an overload condition of an elevator car of an elevator. The method comprises obtaining prevailing car-load information from a load weighing device arranged to weigh a prevailing car-load preferably when the elevator car is standing at a landing floor in an elevator shaft, and determining if said prevailing car-load information fulfils one or more overload criteria; and generating a signal indicating an overload condition of an elevator car, if said car-load information fulfils one or more of said overload criteria.

The method further comprises obtaining information of at least one operational parameter of the elevator, and adjusting one or more of said one or more overload criteria or said car-load information based on said information of the at least one operational parameter of the elevator.

With this kind of solution one or more of the above-mentioned objects can be facilitated. Said adjusting particularly provides a dynamic nature in the overload monitoring and a possibility to take into account operational parameter/parameters of the elevator, which are not constant and/or which are likely to change during elevator lifetime.

In a preferred embodiment, the operational parameter is friction or any parameter suitable for indicating resistance of movement acting directly on the car. Thus, factor(s) affecting the mobility of the car can be taken into account and used as the basis for the adjusting. For example, if the car movement comes to be restricted more than before, e.g. if friction Fᵣ increases, the load weighing device indicates a lower car-load value for same amount of load in elevator car than previously. This problem can be overcome by the aforementioned adjustment the one or more of said overload criteria or the car load information.

In a preferred embodiment, said information of the at least one operational parameter of the elevator includes magnitude of friction or magnitude of a parameter suitable for indicating resistance of movement acting directly on the car.

In a preferred embodiment, the method comprises determining a prevailing car-load value based on said car-load information, and said one or more criteria includes that the prevailing car-load value exceeds at least one threshold.

In a preferred embodiment, the adjusting the one or more criteria comprises changing the value of the threshold to a new value based on the information of at least one operational parameter.

In a preferred embodiment, in said changing the threshold value, the threshold value is changed to a lower value if the obtained information of at least one operational parameter indicates a rise in resistance of movement acting directly on the car and/or to a higher value if the obtained information of at least one operational parameter indicates decrease in resistance of movement acting directly on the car.

In a preferred embodiment, the information of an operational parameter is obtained during movement of the car.

In a preferred embodiment, the load weighing device is arranged to sense the tension of one or more suspension ropes suspending the elevator car.

In a preferred embodiment, the determining comprises reading a memory storing said one or more criteria for an overload condition of an elevator car.

In a preferred embodiment, adjusting criteria comprises accessing a memory storing said one or more criteria for an overload condition of an elevator car and changing said one or more criteria.

In a preferred embodiment, the obtaining information of at least one operational parameter of the elevator comprises moving the car upwards and downwards, and measuring a motor parameter, such as preferably current of the motor of the hoisting machine of the elevator during movement in both said directions.

In a preferred embodiment, each said moving the car upwards and downwards is performed at constant speed, the speed preferably being slow, preferably slower than 0.5 m/s, more preferably slower than 0.2 m/s.

In a preferred embodiment, each said moving the car upwards and downwards is performed while the car is empty.

In a preferred embodiment, the obtaining information of at least one operational parameter of the elevator calculating magnitude of friction or magnitude of any parameter suitable for indicating resistance of movement acting directly on the car, preferably based on said measurements of a motor parameter, preferably measurements of motor currents.

In a preferred embodiment, said calculating comprises calculating a difference between measurements of motor parameters, preferably between a current measured during upwards movement and a current measured during downwards movement.

In a preferred embodiment, the method comprises weighing, in particular by the load weighing device, a prevailing car-load preferably when the elevator car is standing at a landing floor in an elevator shaft. This weighing is preferably performed when the elevator car is standing at a landing floor in an elevator shaft and one or more brakes of the hoisting machine are in a braking state.

It is also brought forward a new overload monitoring system of an elevator, comprising a load weighing device in particular arranged to weigh a prevailing car-load, preferably when the elevator car of the elevator is standing at a landing floor in an elevator shaft; and a control system. The control system is configured to perform the method as defined anywhere above or in any of the claims of the application.

Preferable further details of the overload monitoring system are introduced in the following, which further details can be combined with the overload monitoring system individually or in any combination.

In a preferred embodiment, the control system is configured to obtain car-load information from the load weighing device; and to determine if said prevailing car-load information fulfils one or more overload criteria; and to generate a signal indicating an overload condition of an elevator car, if said car-load information fulfils said overload criteria; and to obtain information of at least operational parameter of the elevator during elevator operation, and to adjust at least one of said one or more overload criteria and said car-load information based on said information of the at least one operational parameter.

In a preferred embodiment, the control system is configured to perform any of the steps of the method described above or in any of the claims of the application.

In a preferred embodiment, the control system comprises a memory storing the one or more criteria for an overload condition of an elevator car or the control system is configured to read and/or change the content of such a memory.

In a preferred embodiment, the control system is connected to a hoisting machine comprising a motor and a drive wheel engaging one or more hoisting ropes of the elevator.

In a preferred embodiment, the control system comprises at least one electronic processing unit (e.g. a microprocessor unit) configured (e.g. programmed) to perform one or more of the following steps: said determining if said prevailing car-load information fulfils one or more overload criteria, said generating a signal, said obtaining information of at least one operational parameter of the elevator, said adjusting.

It is also brought forward a new elevator comprising an elevator car and an overload monitoring system as defined anywhere above or in any of the claims of the application.

Preferable further details of the elevator have been introduced above referring to the method and the and the overload monitoring system. Preferable further details of the elevator will be further introduced in the following. The preferably further details can be combined with the elevator individually or in any combination.

In a preferred embodiment, wherein the control system is configured to control movement of the elevator car in an elevator shaft.

In a preferred embodiment, the elevator comprises suspension ropes for suspending the elevator car.

In a preferred embodiment of the method, an overload monitoring system or the elevator, the operational parameter is friction or any parameter suitable for indicating resistance of movement acting directly on the car.

In a preferred embodiment of the method, an overload monitoring system or the elevator, the car is arranged to be guided by one or more guide rails.

In a preferred embodiment of the method, an overload monitoring system or the elevator, the car comprises one or more guide members taking support in horizontal direction from one or more guide rails.

In a preferred embodiment of the method, an overload monitoring system or the elevator, the load weighing device is arranged to sense the tension of one or more suspension ropes suspending the elevator car.

In a preferred embodiment of the method, an overload monitoring system or the elevator, the load weighing device is arranged in connection with a rope anchor fixing the ends of said one or more suspension ropes to a fixing base.

The fixing base can be for instance a structure of a building, or a structure in the shaft or the car, for example. This may depend on the type of the elevator such as the hoisting ratio thereof. Preferably, the car hangs suspended by the rope anchor. The load weighing device is preferably such that it is arranged to measure a force or forces exerted by the one or more suspension ropes on the rope anchor. For this purpose it preferably comprises one or more force sensors, but also alternative sensors could be used.

In a preferred embodiment of the method, an overload monitoring system or the elevator, the load weighing device is connected to one or more suspension ropes of an elevator car, such that at least part of the force resulting from the load of the elevator car is transmitted via one or more suspension ropes to the load weighing device.

In a preferred embodiment of the method, an overload monitoring system or the elevator, the load weighing device is arranged to measure a force transmitted to it via one or more suspension ropes.

In a preferred embodiment of the method, an overload monitoring system or the elevator, the overload monitoring system, such as preferably the control system thereof, preferably comprises at least one sensor for sensing an operational parameter of an elevator, in particular during movement of the elevator car. Said sensor is preferably a current sensor measuring current of the motor of the hoisting machine.

Generally, the car preferably comprises an interior wherein passenger and/or goods can be transported. The car preferably also comprises one or more doors by which the interior can be opened and closed. The door is preferably an automatic door, whereby comfortable and safe elevator use can be provided by the elevator solution.

### BRIEF DESCRIPTION OF THE DRAWINGS

In the following, the present invention will be described in more detail by way of example and with reference to the attached drawings, in which

FIG. 1 illustrates an elevator and an overload monitoring system, which implement a method according to an embodiment at a moment of normal transport use while the elevator is available to be loaded.

FIG. 2 illustrates the elevator and an overload monitoring system of FIG. 1, at a moment when a step for obtaining information of at least one operational parameter of the elevator is being performed.

### DETAILED DESCRIPTION

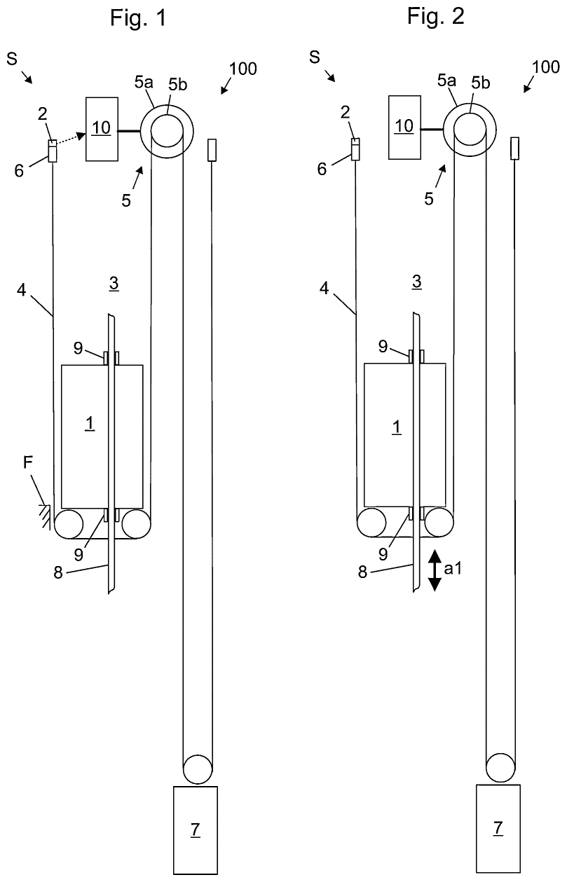

FIG. 1 illustrates an elevator 100 according to an embodiment. The elevator 100 comprises an elevator car 1 positioned in an elevator shaft 3 and an overload monitoring system S according to an embodiment. FIG. 1 illustrates the elevator 100 at a moment of normal transport use while the elevator is available to be loaded, and for this purpose standing at a landing floor F in an elevator shaft 3.

The overload monitoring system S of the elevator 100 comprises a load weighing device 2 in particular arranged to weigh a prevailing car-load when the elevator car 1 of the elevator 100 is standing at a landing floor in an elevator shaft 3; and a control system 10. In the illustrated embodiment, the control system 10 is connected to a hoisting machine 5 comprising a motor 5a and a drive wheel 5b engaging the one or more hoisting ropes 4. The motor 5a is particularly preferably an electric motor, such as for example a permanent magnet motor. The motor 5a can preferably be controlled by an elevator controller comprised in the control system, for instance.

The overload monitoring system S is configured to perform a method according to an embodiment for detecting an overload condition of an elevator car 1 of an elevator 100.

The method comprises, in particular during normal transport use while the elevator car 1 is available to be loaded, obtaining prevailing car-load information from a load weighing device 2 arranged to weigh a prevailing car-load when the elevator car 1 is standing at a landing floor in an elevator shaft 3, and determining if said prevailing car-load information fulfils one or more overload criteria; and generating a signal indicating an overload condition of an elevator car 1, if said car-load information fulfils said overload criteria. Thus, load state of the car 1 is monitored while the elevator car 1 is available to be loaded.

In the preferred embodiment of FIG. 1, the load weighing device 2 is arranged to sense the tension of one or more suspension ropes 4 of the elevator 100. In the preferred embodiment of FIG. 1, this is implemented such that the load weighing device 2 is connected to one or more suspension ropes 4 of an elevator car, such that at least part of the force resulting from the load of the elevator car is transmitted via one or more suspension ropes 4 to the load weighing device 2. The load weighing device 2 illustrated schematically and arranged in connection with a rope anchor 6 fixing the ends of said one or more suspension ropes 4 to a fixing base (not illustrated). The car 1 hangs suspended by the rope anchor 6. The load weighing device 2 is preferably such that it comprises one or more force sensors, such as strain sensors, for example, arranged to measure a force or forces exerted by the one or more suspension ropes 4 on the rope anchor 6.

The method comprises obtaining information of at least one operational parameter of the elevator 100. In the preferred embodiment, the aforementioned operational parameter is friction Fr. Friction is resistance of movement acting directly on the car 1. Friction may be caused e.g. by guide members 9 of the elevator car 1 moving along guide the rails 8 of the elevator 100. Alternatively, the operational parameter could be any other parameter suitable for indicating resistance of movement acting directly on the car 1. Preferred steps related to this step of obtaining information have been illustrated in FIG. 2, and will be described later in more details.

After said obtaining information of at least one operational parameter of the elevator 100, the method comprises adjusting one or more of said overload criteria or alternatively said car-load information based on said information of the at least one operational parameter of the elevator 100. This adjusting provides a dynamic nature in the overload detection and possibility to take into account operational parameters of the elevator, which are not constant and/or are difficult to anticipate and/or are likely to change during elevator lifetime.

Adjustment of the one or more of said overload criteria provides an easy way to provide a correction ability into the overload detection, because a criterium or criteria are typically simple to adjust. As mentioned, it is also possible to adjust the car-load information based on said information of the at least one operational parameter of the elevator 100. Adjusting the car-load information provides a correction to the car-load information, which can efficiently eliminate an error from car-load information e.g. caused by increased friction.

This translates into better accuracy of the car-load information and adjustment of the criteria is not necessary although still possible. In the method, either the car-load information or alternatively the one or more of said one or more overload criteria need to be adjusted based on said information of the at least one operational parameter of the elevator 100, but it is possible to adjust them both.

As mentioned, the operational parameter is preferably friction Fr, which is a parameter suitable for indicating resistance of movement acting directly on the car 1. Thus, factors affecting the mobility of the car 1 can be taken into account and used as the basis for the adjusting. Alternatively, the operational parameter could be any other parameter suitable for indicating resistance of movement acting directly on the car 1. Adjustment on basis of any of these alternatives is advantageous, because the changes in mobility of the car 1 are likely to reduce accuracy of the load weighing. This is particularly the case when the load weighing device 2 is arranged to sense directly or indirectly tension of one or more suspension ropes 4 suspending the elevator car 1. Namely, if movement of the car is not free but resisted e.g. by friction, the forces do not transmit from the car 1 only via ropes 4 but other structures of the elevator provide some carrying forces or braking effect on the car as an effect of friction. Thus, it may be that the vertical forces of the load are not transmitted to the hoisting rope(s) 4 fully and without being affected by friction, and thereby the load inside the car 1 cannot be sensed by the weighing device 2 accurately. If a change is detected in said friction Fr or any other parameter suitable for indicating resistance of movement acting directly on the car 1, the adjustment shall be made.

In the preferred embodiment, said information of the at least one operational parameter of the elevator 100 includes magnitude of friction Fr, such as a value thereof, or magnitude of any parameter suitable for indicating resistance of movement acting directly on the car, such as a value thereof.

After the adjustment, the normal transport use of the elevator is continued.

The aforementioned obtaining information of at least one operational parameter of the elevator 100 may in general be achieved in different ways. In the preferred embodiment illustrated in FIG. 2, this step comprises moving the car 1 upwards and downwards, as indicated by arrow a in FIG. 2. Hereby, collecting information of a parameter, such as preferably said friction, indicating resistance of movement of the car 1, can be facilitated. The method preferably comprises measuring a motor parameter, i.e. a parameter of the motor 5a of the hoisting machine 5 of the elevator 100 during movement in both said directions. The motor parameter is particularly preferably current of the motor of the hoisting machine 5 of the elevator 100.

For the purpose of collecting information of a parameter indicating resistance movement of the car 1, the overload monitoring system S, such as preferably the control system 10 thereof, preferably comprises at least one sensor for sensing the operational parameter of the elevator 100 during movement of the elevator car 1. Said sensor is preferably a current sensor measuring current of the motor 5a of the hoisting machine 5.

In the preferred embodiment, each said moving the car upwards and downwards is performed at constant speed, the speed preferably being slow, preferably slower than 0.5 m/s, more preferably slower than 0.2 m/s.

In the preferred embodiment, each said moving the car upwards and downwards is performed while the car 1 is empty or alternatively with a constant load.

In the preferred embodiment, the obtaining information of at least one operational parameter of the elevator 100 comprises calculating magnitude of friction Fᵣ or magnitude of any parameter suitable for indicating resistance of movement acting directly on the car based on said measurements of a motor parameter, preferably measured currents.

Preferably, said calculating comprises calculating difference between the measurements of motor parameters, preferably between a current measured during upwards movement and a current measured during downwards movement. As friction force acts on the car 1 in both opposite movement directions of the elevator car 1, force/current created by friction can be calculated by calculating current upwards-current downwards, for example.

In the preferred embodiment, the method comprises determining a prevailing car-load value based on said car-load information, and said one or more criteria includes that the prevailing car-load value exceeds at least one threshold. This determining comprises reading a memory storing said one or more criteria for an overload condition of an elevator car.

The adjusting the one or more criteria on the other hand comprises accessing the memory storing said one or more criteria for an overload condition of an elevator car, and changing said one or more criteria. The adjusting the one or more criteria particularly comprises changing the value of the threshold (threshold value) to a new value based on said information of at least one operational parameter, such as based on magnitude of friction Fr or magnitude of a parameter suitable for indicating resistance of movement acting directly on the car 1. The new value can be higher or lower than before. In the preferred embodiment, in said changing the threshold value, the value is changed to a lower value if the obtained information of at least one operational parameter indicates a rise in resistance of movement acting directly on the car 1, preferably more particularly if the magnitude of friction Fr or the magnitude of some other parameter suitable for indicating resistance of movement acting directly on the car 1 is higher than before, such as higher than an earlier magnitude thereof stored in a memory of the control system 10, and vice versa if the obtained information of at least one operational parameter indicates decrease in resistance of movement acting directly on the car 1. The method preferably then comprises comparing the obtained information of at least one operational parameter with a reference, for example by comparing magnitude of friction Fr or the magnitude of some other parameter suitable for indicating resistance of movement acting directly on the car 1 with a reference magnitude thereof stored in a memory of the control system 10.

In the preferred embodiment of FIG. 1, the overload monitoring system S of an elevator, comprises a load weighing device 2 arranged to weigh a prevailing car-load when the elevator car 1 of the elevator 100 is standing at a landing floor in an elevator shaft 3; and a control system 10, which control system 10 is configured to perform the method as described anywhere above. Accordingly, the control system 10 is configured to obtain car-load information from the load weighing device 2; and to determine if said prevailing car-load information fulfils one or more overload criteria; and to generate a signal indicating an overload condition of an elevator car 1, if said car-load information fulfils said overload criteria. The control system 10 is further configured to obtain information of at least operational parameter of the elevator 100, and to adjust at least one of said one or more overload criteria and said car-load information based on said information of the at least one operational parameter. The structure of the monitoring system S is as it has been described earlier referring to FIGS. 1 and 2. Likewise, the monitoring system S is configured to perform steps of the method as it has been described earlier referring to FIGS. 1 and 2.

Generally preferably, the control system 10 preferably comprises a memory storing the one or more criteria for an overload condition of an elevator car or the control system 10 is configured to read and/or change the content of such a memory.

Generally preferably, the control system 10 is configured to control movement of the elevator car 1 in an elevator shaft 3.

Generally preferably, the control system 10 is a local system physically in the vicinity of the elevator car but is can comprise remote units, for example the memory can be a cloud memory. The control system 10 can preferably be or at least comprise a unit known as an elevator controller.

Generally preferably, the control system 10 comprises at least one electronic processing unit e.g. a microprocessor unit configured e.g. programmed to perform one or more of the following steps: said determining if said prevailing car-load information fulfils one or more overload criteria, said generating a signal, said obtaining information of at least one operational parameter of the elevator 100, said adjusting.

Generally preferably, the car 1 is arranged to be guided by one or more guide rails 8. This type of elevator is likely to face during its lifetime changes in friction or other resistance of movement acting directly on the car.

Generally preferably, the car 1 comprises one or more guide members 9 such as roller or slide guides for instance, taking support in horizontal direction from one or more guide rails 8.

Generally preferably, the elevator 100 also comprises a counterweight 7 in the shaft 3 for producing an upwardly pulling force on the car 1. The counterweight being suspended by the hoisting ropes 4, in particular on the opposite side of the a drive wheel 5b than the car 1.

Generally preferably, the hoisting ratio by which the car 1 and/or counterweight 7 is/are suspended could be also different from 2:1 that is shown it the examples, such as 1:1 or 3:1, for example.

Generally, information of at least one operational parameter of the elevator 100 can be landing specific or in general position specific, and the one or more criteria can be landing floor specific or in general position specific, which means that the method, and system S stored for different landing floors/positions separately the one or more overload criteria. In this case, also said obtaining the information of at least one operational parameter of the elevator 100 is performed in landing floor specific manner or in position specific manner, respectively.

As mentioned, the load weighing device 2 is arranged to weigh a prevailing car-load preferably when the elevator car 1 is standing at a landing floor in an elevator shaft 3. This is preferably more specifically such that the load weighing device 2 is arranged to weigh a prevailing car-load when the elevator car 1 is standing at a landing floor in an elevator shaft 3 and one or more brakes of the hoisting machine 5 are in a braking state, in particular in a state where it/they brake and/or prevent rotation of the hoisting machine and/or its drive wheel engaging one or more hoisting ropes. For this purpose, the hoisting machine 5 preferably one or more brakes for braking and/or preventing rotation of the hoisting machine and/or a drive wheel thereof. The control system 10, such as preferably an elevator controller thereof, is preferably configured to control the one or more brakes.

Generally, the method comprises weighing by the load weighing device 2 a prevailing car-load preferably when the elevator car 1 is standing at a landing floor in an elevator shaft 3, more preferably when the elevator car 1 is standing at a landing floor in an elevator shaft 3 and one or more brakes of the hoisting machine 5 are in a braking state.

Generally, the signal indicating an overload condition of an elevator car 1 can be a signal of any kind suitable for indicating said overload condition such as preferably to a human person or to an elevator controller, for example. The signal can be an alarm signal, an electrical signal, a visual signal or a sound signal, or any combination of two or more of these, for instance. The human persons inside the car can react to a signal indicating overload condition. When the signal is electrical, it can be an electrical signal for an elevator controller (described elsewhere) of the control system 10, in response to which the elevator controller is preferably configured to cause stopping of the car for instance, such as by causing braking of one or more brakes of the hoisting machine and/or by causing stopping of rotation of a motor of the hoisting machine, for instance.

As mentioned, the aforementioned obtaining information of at least one operational parameter of the elevator 100 may in general be achieved in different ways. In the preferred embodiment illustrated in FIG. 2, this step comprises moving the car 1 upwards and downwards, as indicated by arrow a in FIG. 2. Hereby, collecting information of a parameter, such as preferably said friction, indicating resistance of movement of the car 1 can be facilitated. As an alternative to the parameter to be measured for both said directions being a motor parameter, the parameter utilized could be a prevailing car-load value determined based on car-load information obtained during movement in both said directions. In this case, the calculating magnitude of friction (Fᵣ) could comprise calculating a difference between prevailing car-load value during upwards movement and prevailing car-load value during downwards movement.

It is to be understood that the above description and the accompanying Figures are only intended to teach the best way known to the inventors to make and use the invention. It will be apparent to a person skilled in the art that the inventive concept can be implemented in various ways. The above-described embodiments of the invention may thus be modified or varied, without departing from the invention, as appreciated by those skilled in the art in light of the above teachings. It is therefore to be understood that the invention and its embodiments are not limited to the examples described above but may vary within the scope of the claims.

1. A method for detecting an overload condition of an elevator car of an elevator, the method comprising the steps of:
obtaining prevailing car-load information from a load weighing device arranged to weigh a prevailing car-load;
determining if said prevailing car-load information fulfils one or more overload criteria;
generating a signal indicating an overload condition of an elevator car, if said car-load information fulfils one or more of said overload criteria,
obtaining information of at least one operational parameter of the elevator, wherein the operational parameter is friction (Fr) or any parameter suitable for indicating resistance of movement acting directly on the car; and
adjusting one or more of said overload criteria or said car-load information based on said information of the at least one operational parameter of the elevator.

2. (canceled)

3. The method according to claim 1, wherein said information of the at least one operational parameter of the elevator includes magnitude of friction (Fr) or magnitude of a parameter suitable for indicating resistance of movement acting directly on the car.

4. The method according to claim 1, wherein the method comprises determining a prevailing car-load value based on said car-load information, and said one or more criteria includes that the prevailing car-load value exceeds at least one threshold.

5. The method according to claim 4, wherein the adjusting the one or more criteria comprises changing the value of the threshold to a new value based on the information of at least one operational parameter.

6. The method according to claim 5, wherein in said changing the threshold value, the threshold value is changed to a lower value if the obtained information of at least one operational parameter indicates a rise in resistance of movement acting directly on the car and/or to a higher value if the obtained information of at least one operational parameter indicates decrease in resistance of movement acting directly on the car.

7. The method according to claim 1, wherein the obtaining information of at least one operational parameter of the elevator comprises moving the car upwards and downwards, and measuring a motor parameter.

8. The method according to claim 1, wherein the obtaining information of at least one operational parameter of the elevator comprises calculating magnitude of friction (Fᵣ) or magnitude of any parameter suitable for indicating resistance of movement acting directly on the car.

9. The method according to claim 8, wherein said calculating comprises calculating a difference between measurements of motor parameters.

10. An overload monitoring system of an elevator, comprising:
a load weighing device arranged to weigh a prevailing car-load; and
a control system configured to perform the method according to claim 1.

11. An elevator comprising an elevator car and the overload monitoring system as defined in claim 10.

12. (canceled)

13. The method according to claim 1, wherein the load weighing device is arranged to sense the tension of one or more suspension ropes suspending the elevator car.

14. The method according to claim 1, wherein the load weighing device is arranged in connection with a rope anchor fixing the ends of one or more suspension ropes of the elevator car to a fixing base.

15. The method according to claim 1, wherein the load weighing device is connected to one or more suspension ropes of an elevator car, such that at least part of the force resulting from the load of the elevator car is transmitted via one or more suspension ropes to the load weighing device.

16. The method according to claim 1, wherein the overload monitoring system or the elevator, such as preferably a control system thereof, comprises at least one sensor for sensing an operational parameter of an elevator.

17. The method according to claim 1, wherein the step of obtaining includes obtaining the prevailing car-load information from the load weighing device arranged to weigh the prevailing car-load when the elevator car is standing at a landing floor in an elevator shaft.

18. The method according to claim 1, wherein the obtaining information of at least one operational parameter of the elevator comprises moving the car upwards and downwards, and measuring a motor parameter, the motor parameter being a current of the motor of the hoisting machine of the elevator during movement in both said directions, and
wherein:
each said moving the car upwards and downwards is performed at constant speed, the speed being slower than 0.5 m/s; and/or
each said moving the car upwards and downwards is performed while the car is empty.

19. The method according to claim 1, wherein the obtaining information of at least one operational parameter of the elevator comprises calculating magnitude of friction (Fᵣ) or magnitude of any parameter suitable for indicating resistance of movement acting directly on the car, based on measurements of a motor parameter, the motor parameter being motor currents.

20. The methodA method according to claim 19, wherein said calculating comprises calculating a difference between a current measured during upwards movement and a current measured during downwards movement.

21. The method according to claim 3, wherein the method comprises determining a prevailing car-load value based on said car-load information, and said one or more criteria includes that the prevailing car-load value exceeds at least one threshold.

22. The method according to claim 3. wherein the obtaining information of at least one operational parameter of the elevator comprises moving the car upwards and downwards. and measuring a motor parameter.
